(19) United States
(12) Patent Application Publication
(10) Pub. No.: US 2024/0005674 A1
(43) Pub. Date: Jan. 4, 2024

(54) ROAD EDGE RECOGNITION BASED ON LASER POINT CLOUD

(71) Applicant: SHANGHAI XIANTU INTELLIGENT TECHNOLOGY CO., LTD., Shanghai (CN)

(72) Inventors: Chao HUANG, Shanghai (CN); Yue YE, Shanghai (CN)

(21) Appl. No.: 18/548,042

(22) PCT Filed: Jan. 6, 2022
(86) PCT No.: PCT/CN2022/070542

§ 371 Date: Aug. 25, 2023

(30) Foreign Application Priority Data
Sep. 29, 2021 (CN) 202111155064.5

(51) Int. Cl. G06V 20/56; G06V 10/44; G01S 17/89

(52) U.S. Cl. CPC G06V 20/588; G06V 10/44; G01S 17/89

(57) ABSTRACT

A road edge recognition method based on a laser point cloud includes: obtaining point cloud data of a current frame collected by a laser radar and pose information corresponding to a current vehicle; determining, based on the pose information, offline road edge points corresponding to the current frame in a pre-stored offline road edge point set; extracting a ground point cloud set by processing the point cloud data; determining, based on a type of the laser radar, a corresponding extraction algorithm to extract candidate road edge points of the current frame from the ground point cloud set; and selecting road edge points closest to the current vehicle in the candidate road edge points and the offline road edge points as target road edge points.

### TECHNICAL FIELD

The present disclosure relates to the field of laser radar technologies, and in particular to a road edge recognition method based on a laser point cloud, an electronic device, and a storage medium.

### BACKGROUND

Along with the development of laser radars and self-driving technologies, self-driving vehicles applicable to various scenarios come into being. For example, a self-driving sweeping vehicle provided with a laser radar may perform automatic sweeping along a road based on a road edge detection result of the laser radar. But, for a general urban road or park road, most of the trashes are located in road edge areas. Therefore, the self-driving sweeping vehicle has to perform close-to-edge sweeping and otherwise, the sweeping quality will be affected. Furthermore, the safety and stability of the self-driving sweeping vehicle should be guaranteed while the close-to-edge sweeping with high accuracy is performed.

### SUMMARY

In view of this, in order to solve the above problem, the present disclosure provides a road edge recognition method based on a laser point cloud, an electronic device, and a storage medium.

According to a first aspect, the present disclosure provides a road edge recognition method based on a laser point cloud, which includes: obtaining point cloud data of a current frame collected by a laser radar and pose information corresponding to a current vehicle; determining, based on the pose information, offline road edge points corresponding to the current frame in a pre-stored offline road edge point set; extracting a ground point cloud set by processing the point cloud data; determining, based on a type of the laser radar, a corresponding extraction algorithm to extract candidate road edge points of the current frame from the ground point cloud set; and selecting road edge points closest to the current vehicle in the candidate road edge points and in the offline road edge points as target road edge points.

In an embodiment, the current vehicle includes a self-driving sweeping vehicle provided with a laser radar and a positioning sensor.

In an embodiment, processing the point cloud data to extract the ground point cloud set includes: selecting a preset number of point clouds as initial point clouds, and performing plane fitting on the initial point clouds based on a random sample consensus algorithm to obtain a plane; calculating a distance of other point cloud from the plane, and determining whether the distance is less than a threshold; in response to determining that the distance is less than the threshold, adding the other point cloud to the ground point cloud set.

In an embodiment, before determining the candidate road edge points of the current frame, the method further includes: based on a selected region of interest, filtering the ground point cloud set to determine ground point clouds in the region of interest; where the region of interest includes a region within a preset distance from both sides of the offline road edge points.

In an embodiment, the type of the laser radar includes a forward radar and a lateral radar; determining, based on the type of the laser radar, the corresponding extraction algorithm to extract the candidate road edge points of the current frame from the ground point cloud set includes: when the laser radar is a forward radar, detecting scanning points on each laser scanning line of the current frame based on sliding window to determine points with a height change exceeding a threshold on each scanning line as the candidate road edge points; when the laser radar is a lateral radar, determining points with a voxel height difference between adjacent voxels along a vertical direction of the current vehicle exceeding a threshold as the candidate road edge points by a voxel gradient algorithm.

In an embodiment, the method further includes: determining the candidate road edge points of the current frame as observation values, and inputting the candidate road edge points of a previous frame into a kinematic model to obtain results as prediction values; and filtering the observation values and the prediction values by a Kalman filtering algorithm to obtain filtered candidate road edge points.

In an embodiment, the offline road edge point set includes road edge points obtained by processing dense point cloud data collected by a laser radar with large number of channels.

In an embodiment, processing the dense point cloud data includes: traversing point cloud data of each frame and merging the point cloud data of the current frame, the point cloud data of a plurality of frames before the current frame and the point cloud data of a plurality of frames after the current frame to obtain merged point cloud data; based on a random sample consensus algorithm, extracting a ground point cloud set from the merged point cloud data; and based on a normal vector feature of a plane formed by ground points near the current vehicle, determining the offline road edge points.

In an embodiment, the method further includes: establishing an actual road edge by fitting the target road edge points.

According to a second aspect, there is provided an electronic device, including: a processor; a memory storing instructions executable by the processor; where the processor is configured to perform the method according to the first aspect.

According to a third aspect, there is provided a non-transitory computer readable storage medium, storing computer programs thereon, where the programs are executed by a processor to perform the method according to the first aspect.

It should be understood that the above general descriptions and subsequent detailed descriptions are merely illustrative and explanatory rather than limiting of the present disclosure.

### BRIEF DESCRIPTION OF DRAWINGS

FIG. 1 is a flowchart illustrating a road edge recognition method based on a laser point cloud according to an exemplary embodiment of the present disclosure.

FIG. 2 is a flowchart illustrating steps of processing dense point cloud data according to an exemplary embodiment of the present disclosure.

FIG. 3 is a schematic diagram illustrating a road edge recognition system based on a laser point cloud according to an exemplary embodiment of the present disclosure.

### DETAILED DESCRIPTION

Exemplary embodiments will be described in detail herein with the examples thereof expressed in the drawings. When the following descriptions involve the drawings, like numerals in different drawings represent like or similar elements unless stated otherwise. The implementations described in the following example embodiments do not represent all implementations consistent with the present disclosure. On the contrary, they are merely examples of an apparatus and a method consistent with some aspects of the present disclosure described in detail in the appended claims.

It is noted that it is not necessary to perform the steps of the corresponding method in a sequence shown in the present disclosure in other embodiments. The steps included in the method in some other embodiments may be more or less than described in the present disclosure. Furthermore, a single step described in present disclosure may be decomposed into several steps for descriptions in other embodiments; and multiple steps described in the present disclosure may be combined into a single step for descriptions in other embodiments.

It is further noted that the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more limitations, an element defined by the statement “including a . . . ” shall not be precluded to include additional same elements present in a process, method, article or device including the elements.

The terms used herein are used for the purpose of describing a particular example only rather than limiting the present disclosure. The singular forms such as “a”, ‘said”, and “the” used in the present disclosure and the appended claims are also intended to include plurality, unless the context clearly indicates otherwise. It is also to be understood that the term “and/or” as used herein refers to and includes any or all possible combinations of one or more associated listed items.

It is to be understood that, although the terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, the second information may also be referred as the first information. Depending on the context, the term “if’ as used herein may be interpreted as “when” or “upon” or “in response to determining”.

Generally, a self-driving sweeping vehicle may, based on a positioning sensor provided on itself, for example, a global positioning system (GPS) sensor, obtain a self-positioning so as to determine its position in a road and then perform close-to-edge sweeping in combination with a road map.

However, once a positioning error occurs or a positioning signal is affected, a large error may occur to the close-to-edge sweeping and even a dangerous event of the vehicle colliding with the road edge may happen.

Therefore, there is provided a method of performing online road edge detection by using a laser radar and generating a road boundary based on the detected road edge. Usually, for the reason of costs, the self-driving sweeping vehicle is provided with a laser radar with small number of channels which collects sparse point cloud data, resulting in a limited accuracy of the online road edge detection result. Furthermore, once a mistake or error occurs to the online detection, the stability and safety of the close-to-edge sweeping may be affected.

In view of this, the present disclosure provides a technical solution in which target road edge points are determined by combining candidate road edge points determined based on point cloud data of a current frame collected in real time with offline road edge points determined based on pre-collected point cloud data.

During implementation, point cloud data of a current frame collected by a laser radar and pose information corresponding to a current vehicle may be firstly obtained.

Next, based on the pose information, offline road edge points corresponding to the current frame in a pre-stored offline road edge point set are determined.

Next, a ground point cloud set is extracted by processing the point cloud data.

Next, based on a type of the laser radar, a corresponding extraction algorithm is determined to extract candidate road edge points of the current frame from the ground point cloud set.

Finally, road edge points closest to the vehicle in the candidate road edge points and the offline road edge points are selected as target road edge points.

In the above technical solution, the offline data corresponding to the current data collected in real time is determined based on the pose information of the vehicle, and by comparing the distances of the online road edge points and the offline road edge points from the vehicle, the road edge points closest to the vehicle are selected as the target road edge points. On one hand, by real-time online road edge detection, the problem of inaccuracy of relying on the offline road edge resulting from positioning error and road change can be avoided and the real-time of the road edge recognition can be guaranteed; on the other hand, candidate road edge points are determined based on point cloud data collected in real time, and then combined with the pre-stored offline road edge points so as to ensure the accuracy of the road edge recognition by using the high-accuracy offline road edge points.

The embodiments of the present disclosure will be described in details below.

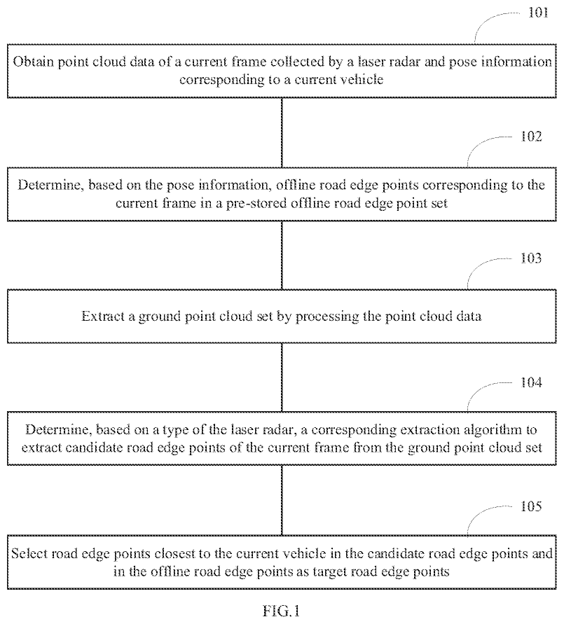

FIG. 1 is a flowchart illustrating a road edge recognition method based on a laser point cloud according to an exemplary embodiment of the present disclosure. As shown in FIG. 1, the method includes the following steps 101 to 105.

At step 101, point cloud data of a current frame collected by a laser radar and pose information corresponding to a current vehicle are obtained.

In an illustrated implementation, the vehicle includes a self-driving sweeping vehicle provided with a laser radar and a positioning sensor.

Usually, for the reason of costs, the laser radar with small number of channels may be employed to perform online road edge detection, where the collected point cloud data is relatively sparse.

For example, a four-channel laser radar may be employed to collect the point cloud data of the current frame.

Furthermore, the current position information may be collected by a positioning sensor, for example, by a GPS sensor.

Furthermore, data of each frame includes the current positioning formation and the point cloud data. Through data processing, the positioning information corresponding to the vehicle may be converted into the pose information corresponding to the vehicle so as to obtain point cloud data of each frame and the pose information corresponding to the vehicle.

For example, by loop closure detection and graph optimization, the GPS positioning data may be converted into Mercator coordinate to obtain the pose information of the vehicle on an XY plane.

It is to be noted that a frame rate refers to a number of circles that a motor of the laser radar rotates within one second, namely, a number of times that one-circle scanning is completed within each second. Point cloud data of one frame refers to one point cloud picture, which corresponds to the point clouds obtained by the motor of the laser radar completing one-circle scanning.

At step 102, based on the pose information, offline road edge points corresponding to the current frame in a pre-stored offline road edge point set are determined.

Since the pre-stored offline road edge point set includes point cloud data and vehicle pose information during offline collection, the offline road edge points corresponding to the current frame may be determined from the offline road edge point set based on the pose information of the current vehicle.

In an illustrated implementation, the offline road edge point set includes the road edge points obtained by processing dense point cloud data collected by a laser radar with large number of channels.

For example, when the point cloud data is collected as the offline road edge points, a laser radar with large number of channels (64/128 channels) may be employed to collect dense point cloud data. In this case, the point cloud data may include much ground information in which the roads and the road edge structures are clear and thus can be used as a high-accuracy map.

Similarly, during offline collection, the positioning data may also be obtained and converted into the pose information of the vehicle under Mercator coordinate, such that data of each frame includes point cloud data and vehicle pose information.

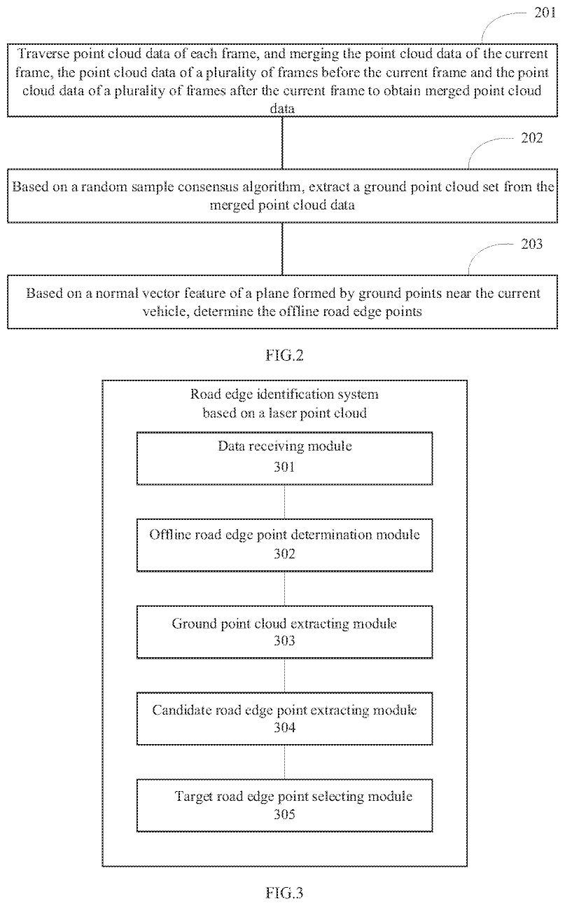

In an illustrated implementation, the processing procedure on the dense point cloud data can be referred to FIG. 2. FIG. 2 is a flowchart illustrating steps of processing dense point cloud data according to an exemplary embodiment of the present disclosure. As shown in FIG. 2, the processing may include the following steps 201 to 203.

At step 201, point cloud data of each frame is traversed, and the point cloud data of the current frame, the point cloud data of a plurality of frames before the current frame and the point cloud data of a plurality of frames after the current frame are merged to obtain merged point cloud data.

Specifically, for point cloud data of each frame, the point cloud data of previous and next frames may be merged.

For example, a value k may be set. When point cloud data of each frame is traversed, for an n-th frame, the point cloud data of the n-th frame, the point cloud data of a plurality of frames before the n-th frame and the point cloud data of a plurality of frames after the n-th frame can be merged such that data of the n-th frame includes vehicle pose information of the n-th frame and the point cloud data obtained by merging the point cloud data of the (n−k)-th frame to the (n+k)-th frame. It can be known that compared with point cloud data of a single frame, the merged point cloud data is denser and has more obvious road edge features.

At step 202, based on a random sample consensus algorithm, a ground point cloud set is extracted from the merged point cloud data.

Specifically, after the above merged dense point cloud data is obtained, based on the random sample consensus algorithm, the ground point cloud set may be determined according to a plane obtained by fitting.

For example, the above merged point cloud data may be divided into different zones based on coordinate. For each zone, a preset amount of point cloud data is randomly selected as initial ground point cloud data from the point cloud data in the current zone. Then, based on the initial ground point cloud data, plane fitting is performed based on the random sample consensus algorithm to obtain a ground description model of each zone. Finally, a distance of the point cloud in each zone from the plane obtained by fitting is calculated. If the distance is less than a preset threshold, the point clouds may be classified as ground points and otherwise, as obstacle points.

The specific amount of the above selected point clouds and the value of the threshold are not limited in the present disclosure and can be set by those skilled in the art based on actual requirements.

In other words, since the ground points and the road edge points have a limited height, the ground points can be selected based on a height feature by referring to a ground obtained by fitting.

At step 203, based on a normal vector feature of a plane formed by ground points near the current vehicle, the offline road edge points are determined.

Specifically, ground point clouds within a preset distance from the vehicle may be selected and a normal vector of the plane is calculated to determine the offline road edge points.

For example, the ground point cloud data within a preset distance from both sides of the vehicle may be selected and a normal vector of a plane formed by the points around each point is calculated as a normal vector feature of this point. Since the road edge is vertical to the ground, the normal vectors of the road edge points in the dense point clouds all have the feature of being parallel to the ground and pointing toward the inner side of the road. Therefore, the offline road edge points can be determined through the above calculation.

The preset distance from both sides of the vehicle is not limited in the present disclosure and may be set by those skilled in the art based on actual requirements.

In an embodiment, outliers and noise points may be filtered from the offline road edge points by using a filter to obtain a road edge point set.

In the above pre-processing on the offline road edge points, the offline road edge points are collected by using a laser radar with large number of channels, and the point cloud data of a plurality of frames is merged, such that point cloud data of each frame is denser, thereby both the high accuracy of the offline road edge points and the correctness of the offline road edge points are ensured.

Extracting the online road edge points is further described below.

At step 103, a ground point cloud set is extracted by processing the point cloud data.

Specifically, the point cloud data of the current frame collected by the laser radar may be processed to determine the ground point cloud set.

In an illustrated implementation, a preset number of point clouds may be selected as initial point clouds, and plane fitting is performed on the initial point clouds based on the random sample consensus algorithm to obtain a plane; a distance of other point cloud from the plane is calculated and whether the distance is less than a threshold is determined; if the distance is less than the threshold, the other point cloud is added to the ground point cloud set.

For example, a preset number of point clouds may be randomly selected as initial point clouds, and plane fitting is performed on the initial point clouds based on the random sample consensus algorithm to obtain a plane; a distance of other point cloud from the plane is calculated and whether the distance is less than a threshold is determined; if the distance is less than the threshold, the other point cloud is added to the ground point cloud set; and if the distance is not less than the threshold, the other point cloud is removed from the point cloud data.

The ground point cloud set includes the road edge points, and the road edge points need to be further determined from the ground point cloud set based on a preset extraction algorithm.

Before the above operation, further screening may be performed on the ground point cloud set in combination with the offline road edge points to reduce the size of the point cloud data to be processed.

In an illustrated implementation, based on a selected region of interest, the ground point cloud set is filtered to determine ground point clouds in the region of interest; where the region of interest includes a region within a preset distance from both sides of the offline road edge points.

For example, after the offline road edge points corresponding to the current frame are determined, with the offline road edge points as reference, a region within a preset distance from both sides of the offline road edge points may be selected as a region of interest. Further, based on the region of interest, the ground point cloud set determined from the online collection of the laser radar may be screened to determine the ground point clouds in the region of interest.

In the above step 103, those parts to be preset will be selected by those skilled in the art, which is not limited herein.

At step 104, based on a type of the laser radar, a corresponding extraction algorithm is determined to extract candidate road edge points of the current frame from the ground point cloud set.

It is to be noted that the laser radar is usually mounted on the top of the vehicle or on the periphery of the vehicle. The laser radar mounted on the periphery of the vehicle usually has channels of less than 8, and the laser radar mounted on the top of the vehicle usually has channels of no less than 16.

In an example, the self-driving sweeping vehicle may obtain the offline road edge points by the steps 201 to 203 based on the dense point cloud data collected by the laser radar with large number of channels mounted on the top of the vehicle.

In another example, the self-driving sweeping vehicle may collect real-time point cloud data for online road edge detection by using the laser radars with small number of channels mounted on the front and sides of the vehicle.

Since the distribution morphologies of the point clouds collected by the laser radars at different positions are different, different extraction algorithms may be adopted for the laser radars at different positions to determine the road edge points.

Specifically, the type of the laser radar may be a mounting position of the laser radar, and based on a different mounting position of the laser radar, a corresponding extraction algorithm is determined to extract the candidate road edge points of the current frame from the ground point cloud set.

In an illustrated implementation, the type of the laser radar includes a forward radar and a lateral radar.

Specifically, when the laser radar is a forward radar, scanning points on each laser scanning line of the current frame are detected based on sliding window to determine points with a height change exceeding a threshold on each scanning line as the candidate road edge points.

For example, if the scanning points on a scanning line are P1, P2, P3, . . . and Pn from left to right, the above scanning points are traversed to calculate a height difference from the point Pk−a to the point Pk+b, where the values of a and b may be adjusted based on experiences. If the height difference is greater than a preset threshold, the points between the point Pk−a and the point Pk+b are filtered to obtain the candidate road edge points on the scanning line, and the above step is repeated until extraction for the candidate road edge points on all scanning lines is completed.

During detection, the scanning lines may be divided into left and right sides with the scanning central point of the scanning lines as center, and then the above detection operation is performed on the left and right sides respectively.

Specifically, when the laser radar is a lateral radar, points with a voxel height difference between adjacent voxels along a vertical direction of the vehicle exceeding a threshold are determined as the candidate road edge points based on a voxel gradient algorithm.

For example, all points within a side surface of a vehicle body are divided into k*k voxels. For each voxel, a minimum value of heights of the internal points of the voxel is calculated as a height of the voxel. Along an advance direction of the vehicle body, adjacent voxels along a vertical direct of the vehicle are traversed from left to right sequentially. When the height difference between adjacent voxels exceeds a preset threshold, the point is taken as the candidate road edge point.

The side surface of the vehicle body may be divided into left and right sides and then the above voxel gradient processing is performed on the left and right sides respectively.

Further, the thresholds of the height difference on the scanning lines and the height difference between voxels can be selected by those skilled in the art, which is not limited in the present disclosure.

Since the point cloud data collected by the laser radar with small number of channels is relatively sparse, several frames of road edge results may also be tracked to ensure the stability of the real-time road edge detection result.

In an illustrative implementation, the candidate road edge points of the current frame are determined as observation values and the candidate road edge points of a previous frame are input into a kinematic model to obtain results as prediction values; the observation values and the prediction values are filtered by a Kalman filtering algorithm to obtain filtered candidate road edge points.

For example, the kinematic model of the self-driving sweeping vehicle is a constant turn rate and velocity model. Supposing the observed and estimated noises both satisfy Gaussian noise, the candidate road edge points of the previous frame may be predicted based on the kinematic model to obtain prediction values of the candidate road edge points of the previous frame moving to the current frame, and the candidate road edge points obtained by performing online detection on the current frame are taken as the observation values; and then the observation values and the prediction values are filtered based on Kalman filtering to obtain filtered candidate road edge points.

At step 105, road edge points closest to the vehicle in the candidate road edge points and in the offline road edge points are selected as target road edge points.

Specifically, based on the distances of the candidate road edge points currently detected online by the vehicle from the vehicle and the distances of the offline road edge points corresponding to the current pose of the vehicle from the vehicle, the road edge points closest to the vehicle are determined as the target road edge points.

For example, in order to ensure possible close-to-edge sweeping, the online detected road edge points may be compared with the pre-stored offline road edge points to select the points closest to the vehicle as the target road edge points.

In an illustrated implementation, an actual road edge can be established by fitting the target road edge points.

Specifically, based on a preset curve fitting algorithm, fitting may be performed on the final target road edge points to establish the actual road edge.

Furthermore, after the above actual road edge is obtained, a planned reference line of a vehicle center of the self-driving sweeping vehicle and a planned reference line of a sweeping brush of the self-driving sweeping vehicle may be generated at the same time based on a dynamic programming algorithm. Then, based on an optimized trajectory generation algorithm, static obstacle, road boundary, dynamic obstacle, and mapping speed limit and the like are input, and the defined optimization target problem fully takes into account several constraint conditions such as the vehicle center reference line of the self-driving vehicle, the sweeping brush reference line, the acceleration change amount, the distance from the obstacle, the curvature of the trajectory, and vehicular dynamics limitations, and then a high-accuracy close-to-edge trajectory can be generated by using a solver, which is not limited in the present disclosure.

In the above technical solution, based on pose information of a vehicle, offline data corresponding to current data collected in real time is determined, and by comparing the distances of the online road edge points and the offline road edge points from the vehicle, the road edge points closest to the vehicle are selected as target road edge points. On one hand, by real-time online road edge detection, the problem of inaccuracy of relying on the offline road edge resulting from positioning error and road change can be avoided and the real-time of the road edge recognition can be guaranteed; on the other hand, candidate road edge points are determined based on point cloud data collected in real time, and then combined with the pre-stored offline road edge points so as to ensure the accuracy of the road edge recognition by using the high-accuracy offline road edge points.

Corresponding to the above method embodiments, the present disclosure further provides an embodiment of a road edge recognition system based on a laser point cloud. FIG. 3 is a schematic diagram illustrating a road edge recognition system based on a laser point cloud according to an exemplary embodiment of the present disclosure. The system includes a data receiving module 301, configured to obtain point cloud data of a current frame collected by a laser radar and pose information corresponding to a current vehicle; an offline road edge point determination module 302, configured to, determine, based on the pose information, offline road edge points corresponding to the current frame in a pre-stored offline road edge point set; a ground point cloud extracting module 303, configured to extract a ground point cloud set by processing the point cloud data; a candidate road edge point extracting module 304, configured to, determine, based on a type of the laser radar, a corresponding extraction algorithm to extract candidate road edge points of the current frame from the ground point cloud set; a target road edge point selecting module 305, configured to select road edge points closest to the current vehicle in the candidate road edge points and in the offline road edge points as target road edge points.

In an embodiment, the current vehicle includes a self-driving sweeping vehicle provided with a laser radar and a positioning sensor.

In an embodiment, the ground point cloud extracting module is further configured to: select a preset number of point clouds as initial point clouds, and performing plane fitting on the initial point clouds based on a random sample consensus algorithm to obtain a plane; calculate a distance of other point clouds from the fitted plane, and determining whether the distance is less than a threshold; and in response to determining that the distance is less than the threshold, add the other point clouds to the ground point cloud set.

In an embodiment, the system further includes: a region-of-interest filtering module configured to, based on a selected region of interest, filter the ground point cloud set to determine ground point clouds in the region of interest; where the region of interest includes a region within a preset distance from both sides of the offline road edge points.

In an embodiment, the type of the laser radar includes a forward radar and a lateral radar; the candidate road edge point extracting module is further configured to: when the laser radar is a forward radar, detect scanning points on each laser scanning line of the current frame based on sliding window to determine points with a height change exceeding a threshold on each scanning line as the candidate road edge points; when the laser radar is a lateral radar, determine points with a voxel height difference between adjacent voxels along a vertical direction of the current vehicle exceeding a threshold as the candidate road edge points by a voxel gradient algorithm.

In an embodiment, the system further includes a filtering module, configured to: determine the candidate road edge points of the current frame as observation values and input the candidate road edge points of a previous frame into a kinematic model to obtain results as prediction values; and filter the observation values and the prediction values by a Kalman filtering algorithm to obtain filtered candidate road edge points.

In an embodiment, the offline road edge point set includes road edge points obtained by processing dense point cloud data collected by a laser radar with large number of channels.

In an embodiment, processing the dense point cloud data includes: traversing point cloud data of each frame, and merging the point cloud data of the current frame, the point cloud data of a plurality of frames before the current frame and the point cloud data of a plurality of frames after the current frame to obtain merged point cloud data; based on a random sample consensus algorithm, extracting a ground point cloud set from the merged point cloud data; and based on normal vector features of a plane formed by ground points near the current vehicle, determining the offline road edge points.

In an embodiment, the system further includes an establishing module, configured to, establish an actual road edge by fitting the target road edge points.

The embodiments of the present disclosure are described in a progressive manner with same or similar parts between the embodiments referred to each other, and each embodiment focuses on descriptions of the differences from other embodiments.

Since the system embodiments substantially correspond to the method embodiments, a reference may be made to part of the descriptions of the method embodiments for the related part. The system embodiments described above are merely illustrative, where the modules described as separate members may be or not be physically separated, and the members displayed as modules may be or not be physical, modules, i.e., may be located in one place, or may be distributed to a plurality of network modules. Part or all of the modules may be selected according to actual requirements to implement the objectives of the solutions in the embodiments. Those of ordinary skill in the art may understand and carry out them without creative work.

The systems, apparatuses, modules or units described in the above embodiments may be specifically implemented by a computer chip or an entity or may be implemented by a product with a particular function. A typical implementing device may be a computer and the computer may be specifically a personal computer, a laptop computer, a cellular phone, a camera phone, a smart phone, a personal digital assistant, a media player, a navigation device, an email transceiver, a game console, a tablet computer, a wearable device, or a combination of any several devices of the above devices.

Corresponding to the above method embodiment, the present disclosure further provides an embodiment of an electronic device. The electronic device includes a processor and a memory for storing machine executable instructions, where the processor and the memory are connected with each other via an internal bus. In other possible implementations, the device may also include an external interface to communicate with other devices or components.

In this embodiment, by reading and executing machine executable instructions corresponding to user identity authentication logic in the memory, the processor is caused to: obtain point cloud data of a current frame collected by a laser radar and pose information corresponding to a current vehicle; based on the pose information, determine offline road edge points corresponding to the current frame in a pre-stored offline road edge point set; process the point cloud data to extract a ground point cloud set; based on a type of the laser radar, determine a corresponding extraction algorithm to extract candidate road edge points of the current frame from the ground point cloud set; take road edge points closest to the vehicle in the candidate road edge points and the offline road edge points as target road edge points.

Corresponding to the above method embodiments, an embodiment of the present disclosure further provides a computer readable storage medium storing computer programs, where these computer programs are executed by a processor to perform the steps of the road edge recognition method based on a laser point cloud in the embodiments of the present disclosure. The detailed descriptions of the steps of the road edge recognition method based on a laser point cloud can be referred to the above contents and will not be repeated herein.

In one typical configuration, the computing device may include one or more processors (CPU), an input and output interface, a network interface and a memory.

The memory may include a non-permanent memory in the computer readable medium, a random access memory (RAM) and/or a non-volatile memory and the like, for example, a Read Only Memory (ROM) or a flash RAM. The memory is only an example of the computer readable medium.

The computer readable medium includes permanent and non-permanent, removable and non-removable media which can realize information storage by any method or technology. The information may be computer readable instructions, data structures, program modules or other data.

The examples of the computer storage medium include but not limited to: a phase change random access memory (PRAM), a Static Random Access Memory (SRAM), a Dynamic Random Access Memory (DRAM), and other types of RAMs, a Read-Only Memory (ROM), an Electrically-Erasable Programmable Read-Only Memory (EEPROM), a Flash Memory, or other memory technology, CD-ROM, digital versatile disc (DVD) or other optical storage, cassette type magnetic tape, magnetic disk storage or other magnetic storage device or other non-transmission medium for storing information accessible by computing devices. As defined in the present disclosure, the computer readable medium does not include transitory computer readable media such as modulated data signals or carriers.

Persons skilled in the art shall understand that one or more embodiments of the present disclosure may be provided as methods, systems, or computer program products. Thus, one or more embodiments of the present disclosure may be adopted in the form of entire hardware embodiments, entire software embodiments or embodiments combining software and hardware. Further, one or more embodiments of the present disclosure may be adopted in the form of computer program products that are implemented on one or more computer available storage media (including but not limited to magnetic disk memory, CD-ROM, and optical memory and so on) including computer available program codes.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims.

The foregoing disclosure is merely illustrative of preferred embodiments of the present disclosure but not intended to limit the present disclosure, and any modifications, equivalent substitutions, improvements thereof made within the spirit and principles of the disclosure shall be encompassed in the scope of protection of the present disclosure.

1. A road edge recognition method based on a laser point cloud, comprising:
obtaining point cloud data of a current frame collected by a laser radar and pose information corresponding to a current vehicle;
determining, based on the pose information, offline road edge points corresponding to the current frame in a pre-stored offline road edge point set;
extracting a ground point cloud set by processing the point cloud data;
determining, based on a type of the laser radar, a corresponding extraction algorithm to extract candidate road edge points of the current frame from the ground point cloud set; and
selecting road edge points closest to the current vehicle in the candidate road edge points and in the offline road edge points as target road edge points.

2. The method of claim 1, wherein the current vehicle comprises a self-driving sweeping vehicle provided with a laser radar and a positioning sensor.

3. The method of claim 1, wherein processing the point cloud data to extract the ground point cloud set comprises:
selecting a preset number of point clouds as initial point clouds, and performing plane fitting on the initial point clouds based on a random sample consensus algorithm to obtain a plane;
calculating a distance of other point cloud from the plane, and determining whether the distance is less than a threshold; and
in response to determining that the distance is less than the threshold, adding the other point cloud to the ground point cloud set.

4. The method of claim 1, further comprising, before determining the candidate road edge points of the current frame:
based on a selected region of interest, filtering the ground point cloud set to determine ground point clouds in the region of interest, wherein the region of interest comprises a region within a preset distance from both sides of the offline road edge points.

5. The method of claim 1, wherein the type of the laser radar comprises a forward radar and a lateral radar;
determining, based on the type of the laser radar, the corresponding extraction algorithm to extract the candidate road edge points of the current frame from the ground point cloud set comprises:
when the laser radar is a forward radar, detecting scanning points on each laser scanning line of the current frame based on sliding window to determine points with a height change exceeding a threshold on each scanning line as the candidate road edge points;
when the laser radar is a lateral radar, determining points with a voxel height difference between adjacent voxels along a vertical direction of the current vehicle exceeding a threshold as the candidate road edge points by a voxel gradient algorithm.

6. The method of claim 1, further comprising:
determining the candidate road edge points of the current frame as observation values, and inputting the candidate road edge points of a previous frame into a kinematic model to obtain results as prediction values; and
filtering the observation values and the prediction values by a Kalman filtering algorithm to obtain filtered candidate road edge points.

7. The method of claim 1, wherein the offline road edge point set comprises road edge points obtained by processing dense point cloud data collected by a laser radar with large number of channels.

8. The method of claim 7, wherein processing the dense point cloud data comprises:
traversing point cloud data of each frame, and merging the point cloud data of the current frame, the point cloud data of a plurality of frames before the current frame and the point cloud data of a plurality of frames after the current frame to obtain merged point cloud data;
based on a random sample consensus algorithm, extracting a ground point cloud set from the merged point cloud data; and
based on a normal vector feature of a plane formed by ground points near the current vehicle, determining the offline road edge points.

9. The method of claim 1, further comprising:
establishing an actual road edge by fitting the target road edge points.

10. (canceled)

11. An electronic device, comprising:
a processor;
a memory storing instructions executable by the processor;
wherein the processor is configured to perform operations comprising:
obtaining point cloud data of a current frame collected by a laser radar and pose information corresponding to a current vehicle;
determining, based on the pose information, offline road edge points corresponding to the current frame in a pre-stored offline road edge point set;
extracting a ground point cloud set by processing the point cloud data;
determining, based on a type of the laser radar, a corresponding extraction algorithm to extract candidate road edge points of the current frame from the ground point cloud set; and
selecting road edge points closest to the current vehicle in the candidate road edge points and in the offline road edge points as target road edge points.

12. The electronic device of claim 11, wherein the current vehicle comprises a self-driving sweeping vehicle provided with a laser radar and a positioning sensor.

13. The electronic device of claim 11, wherein processing the point cloud data to extract the ground point cloud set comprises:
selecting a preset number of point clouds as initial point clouds, and performing plane fitting on the initial point clouds based on a random sample consensus algorithm to obtain a plane;
calculating a distance of other point cloud from the plane, and determining whether the distance is less than a threshold; and
in response to determining that the distance is less than the threshold, adding the other point cloud to the ground point cloud set.

14. The electronic device of claim 11, wherein the operations further comprise, before determining the candidate road edge points of the current frame:
based on a selected region of interest, filtering the ground point cloud set to determine ground point clouds in the region of interest, wherein the region of interest comprises a region within a preset distance from both sides of the offline road edge points.

15. The electronic device of claim 11, wherein the type of the laser radar comprises a forward radar and a lateral radar;
determining, based on the type of the laser radar, the corresponding extraction algorithm to extract the candidate road edge points of the current frame from the ground point cloud set comprises:
when the laser radar is a forward radar, detecting scanning points on each laser scanning line of the current frame based on sliding window to determine points with a height change exceeding a threshold on each scanning line as the candidate road edge points;
when the laser radar is a lateral radar, determining points with a voxel height difference between adjacent voxels along a vertical direction of the current vehicle exceeding a threshold as the candidate road edge points by a voxel gradient algorithm.

16. The electronic device of claim 11, wherein the operations further comprise:
determining the candidate road edge points of the current frame as observation values, and inputting the candidate road edge points of a previous frame into a kinematic model to obtain results as prediction values; and
filtering the observation values and the prediction values by a Kalman filtering algorithm to obtain filtered candidate road edge points.

17. The electronic device of claim 11, wherein the offline road edge point set comprises road edge points obtained by processing dense point cloud data collected by a laser radar with large number of channels.

18. The electronic device of claim 17, wherein processing the dense point cloud data comprises:
traversing point cloud data of each frame, and merging the point cloud data of the current frame, the point cloud data of a plurality of frames before the current frame and the point cloud data of a plurality of frames after the current frame to obtain merged point cloud data;
based on a random sample consensus algorithm, extracting a ground point cloud set from the merged point cloud data; and
based on a normal vector feature of a plane formed by ground points near the current vehicle, determining the offline road edge points.

19. The electronic device of claim 11, wherein the operations further comprise:
establishing an actual road edge by fitting the target road edge points.

20. A non-transitory computer readable storage medium, storing computer programs thereon, wherein the programs, when executed by a processor, cause the processor to perform operations comprising:
obtaining point cloud data of a current frame collected by a laser radar and pose information corresponding to a current vehicle;
determining, based on the pose information, offline road edge points corresponding to the current frame in a pre-stored offline road edge point set;
extracting a ground point cloud set by processing the point cloud data;
determining, based on a type of the laser radar, a corresponding extraction algorithm to extract candidate road edge points of the current frame from the ground point cloud set; and
selecting road edge points closest to the current vehicle in the candidate road edge points and in the offline road edge points as target road edge points.
